(19) United States
(12) Patent Application Publication
(10) Pub. No.: US 2017/0155142 A1
(43) Pub. Date: Jun. 1, 2017

(54) COMPOSITE LITHIUM SECONDARY BATTERY

(71) Applicant: ENERGY CONTROL LIMITED, Tortola (VG)

(72) Inventor: Donald P.H. WU, HSINCHU COUNTY (TW)

(21) Appl. No.: 14/956,146

(22) Filed: Dec. 1, 2015

(51) Int. Cl. H01M 4/505; H01M 10/0587; H01M 4/587; H01M 10/052; H01M 4/58; H01M 4/525

(52) U.S. Cl. CPC H01M 4/505; H01M 4/5825; H01M 4/525; H01M 4/587; H01M 10/052; H01M 10/0587; H01M 2004/028

(57) ABSTRACT

A composite lithium secondary battery, and the electrode layer assembly of the secondary battery includes: a plurality of positive electrode layers, a plurality of negative electrode layers and a plurality of separating layers disposed between the positive and negative electrode layers. The two opposite surfaces of the respective positive electrode layers are coated with the same positive electrode material which is LiFePO₄ or lithium-containing ternary oxide, at least one of the positive electrode layers is coated with LiFePO₄, and at least another one of the positive electrode layers is coated with lithium-containing ternary oxide, so that during the process of charge and discharge, the lithium secondary battery would have the advantages of different positive electrode materials.

### BACKGROUND OF THE INVENTION

Field of the Invention

The present invention relates to a secondary lithium battery, and more particularly to a composite lithium secondary battery whose positive electrode is coated with different positive electrode materials.

Related Prior Art

In recent years, portable electronic devices, such as video camera, digital still camera, mobile phone, and notebook computer, have been widely used. In order to make the electronic devices easy to carry and have a prolonged working time, how to reduce the size and weight of the battery while extending the service life thereof has become the main technical problem that has to be solved. Therefore, lightweight secondary batteries with high energy density have been developed and used as power source of the portable electronic devices.

The charge and discharge in lithium secondary battery occurs by the process of intercalation and deintercalation of lithium ions. The lithium secondary battery has been widely used due to it provides higher energy density than the lead battery and Ni—Cd battery do. As shown in FIG. 1A, the existing lithium secondary battery A includes positive and negative electrode members and a separating layer disposed therebetween to form an electrode layer A1, and then a plurality of such electrode layers A1 are put into a housing A2 of a square battery, or as shown in FIG. 1B, a plurality of such electrode layers A1 roll into a coil to form a core assembly A3 which is then put into a housing A2 of a rectangular battery. The lithium secondary battery includes electrolyte, positive electrode and negative electrode. The positive electrode is formed by coating a positive plate with positive electrode active material, the negative electrode is formed by coating a negative plate with negative electrode active material, and the electrolyte is a dissolvent containing electorate. The positive and negative electrode materials are most important factors to improve the capacitance density of the lithium secondary battery.

As for the negative electrode material, the change in the crystal structure of the carbon material is very small during the process of intercalation and deintercalation of lithium ions, therefore, currently, carbon material, such as graphite, has been widely adopted as negative electrode material, in order to enhance the property, such as capacitance of the lithium battery. The positive electrode materials normally used in lithium battery includes LiCoO₂, LiNiO₂, LiMn₂O₄, LiMnO₂, LiNiCoMnO₂, LNCM, LiNixCoyAl_{1-x-y}O₂, LNCA, LiFePO₄, LFP.

It should be noted that the current positive electrode is made by casting a both lateral surfaces of a positive plate with a single positive electrode material. However, different positive electrode materials have respective merits and faults. For example, LiMn₂O₄ has a low capacitance but a high thermal safety, therefore, it is suitable for use in medium and large high power battery. LiFePO₄ has a higher thermal safety than LiMn₂O₄, and has no risk of explosion or overheat, therefore it is suitable for use in large high power battery. The lithium secondary battery with a single type of positive electrode material only can have good performance in some of the characteristics.

The present invention has arisen to mitigate and/or obviate the afore-described disadvantages.

### SUMMARY

The present invention is aimed at providing a composite lithium secondary battery, wherein a plurality of positive electrode layers of the electrode layer assembly are coated with different positive electrode materials which are selected from the group consisting of LFP (LiFePO₄) and lithium-containing ternary oxides, at least one of the positive electrode layers is coated with LiFePO₄, and at least another one of the positive electrode layers is coated with lithium-containing ternary oxide, so that, during the process of charge and discharge, the lithium secondary battery would have the advantages of different positive electrode materials, so as to provide a composite lithium secondary battery with high voltage, high capacitance and high safety.

To achieve the above objective, a composite lithium secondary battery in accordance with the present invention comprises an electrode layer assembly, and the electrode layer assembly comprises: a plurality of positive electrode layers, a plurality of negative electrode layers and a plurality of separating layers disposed between the positive and negative electrode layers, wherein the positive and negative electrode layers and the separating layer are superimposed one another to form the electrode layer assembly. The positive electrode layers are provided with positive electrode materials which allow for intercalation and deintercalation of electrode reaction material, at least one positive electrode ear is provided at a lateral edge of each of the positive electrode layers, two opposite surfaces of each of the positive electrode layers are provided with the positive electrode materials, the negative electrode layers being provided with negative electrode materials which allow for intercalation and deintercalation of the electrode reaction material, at least one negative electrode ear is provided at a lateral edge of each of the negative electrode layers. The composite lithium secondary battery is characterized in that: the two opposite surfaces of the respective positive electrode layers are coated with the same positive electrode material which is LiFePO₄ or lithium-containing ternary oxide, at least one of the positive electrode layers is coated with LiFePO₄, and at least another one of the positive electrode layers is coated with lithium-containing ternary oxide.

Preferably, the lithium-containing ternary oxide is selected from the group consisting of LiNixCoyAl_{1-x-y}O₂ or LiNiCoMnO₂, or LiFePO₄ and LiNixCoyAl_{1-x-y}O₂. The composite lithium secondary battery with LFP+LNCA has a working voltage ranging from 4.5 V to 2.7 V, and a capacitance over 175 mAh/g. The composite lithium secondary battery with LFP+LNCA has a working voltage ranging from 4.4 V to 2.6 V, and a capacitance over 185 mAh/g.

Preferably, the two opposite surfaces of the respective positive electrode layers are respectively formed into a coating layer after being coated with the positive electrode material, the coating layer coated with LiNixCoyAl_{1-x-y}O₂ or LiNiCoMnO₂ is defined as a first coating layer, the positive electrode layer whose two opposite surfaces coated with the first coating layer is defined as a ternary positive electrode layer, the coating layer coated with LiFePO₄ is defined as a second coating layer, the positive electrode layer whose two opposite surfaces coated with the second coating layer is defined as an LiFePO₄ positive electrode layer, the electrode layer assembly comprises one said LiFePO₄ positive electrode layer and two said ternary positive electrode layers which are superimposed one another, or two said LiFePO₄ positive electrode layers and one said ternary positive electrode layer which are superimposed one another. The electrode layer assembly can also comprise one said LiFePO₄ positive electrode layer and three said ternary positive electrode layers which are superimposed one another, or two said LiFePO₄ positive electrode layers and two said ternary positive electrode layers which are superimposed one another, or three said LiFePO₄ positive electrode layers and one said ternary positive electrode layer which are superimposed one another.

Preferably, the negative electrode materials include carbon materials of graphite or coke.

Preferably, the positive electrode layers, the negative electrode layers and the separating layers are superimposed one another and rolled up into a coiled core assembly.

### BRIEF DESCRIPTION OF THE DRAWINGS

FIG. 1A is a perspective view showing that an electrode layer assembly of a conventional lithium secondary battery is in a square battery housing;

FIG. 1B is a perspective view showing that an electrode layer assembly of a conventional lithium secondary battery is in a circular battery housing;

FIG. 2A is an exploded view of an electrode layer assembly of a square type composite lithium secondary battery in accordance with the present invention;

FIG. 2B is an exploded view of an electrode layer assembly of a circular type composite lithium secondary battery in accordance with the present invention;

FIG. 3 is a side view of the electrode layer assembly of the composite lithium secondary battery in accordance with the present invention;

FIG. 4 is an illustrative view of showing the coating and configuration of the electrode layer assembly of the composite lithium secondary battery in accordance with the present invention;

FIG. 5A is a first illustrative view of showing the coating and configuration of the electrode layer assembly of the composite lithium secondary battery in accordance with the present invention which comprises three positive electrode layers;

FIG. 5B is a second illustrative view of showing the coating and configuration of the electrode layer assembly of the composite lithium secondary battery in accordance with the present invention which comprises three positive electrode layers;

FIG. 5C is a third illustrative view of showing the coating and configuration of the electrode layer assembly of the composite lithium secondary battery in accordance with the present invention which comprises three positive electrode layers;

FIG. 5D is a fourth illustrative view of showing the coating and configuration of the electrode layer assembly of the composite lithium secondary battery in accordance with the present invention which comprises three positive electrode layers;

FIG. 6A is a first illustrative view of showing the coating and configuration of the electrode layer assembly of the composite lithium secondary battery in accordance with the present invention which comprises four positive electrode layers;

FIG. 6B is a second illustrative view of showing the coating and configuration of the electrode layer assembly of the composite lithium secondary battery in accordance with the present invention which comprises four positive electrode layers;

FIG. 6C is a third illustrative view of showing the coating and configuration of the electrode layer assembly of the composite lithium secondary battery in accordance with the present invention which comprises four positive electrode layers;

FIG. 6D is a fourth illustrative view of showing the coating and configuration of the electrode layer assembly of the composite lithium secondary battery in accordance with the present invention which comprises four positive electrode layers;

FIG. 6E is a fifth illustrative view of showing the coating and configuration of the electrode layer assembly of the composite lithium secondary battery in accordance with the present invention which comprises four positive electrode layers;

FIG. 6F is a sixth illustrative view of showing the coating and configuration of the electrode layer assembly of the composite lithium secondary battery in accordance with the present invention which comprises four positive electrode layers;

FIG. 6G is a seventh illustrative view of showing the coating and configuration of the electrode layer assembly of the composite lithium secondary battery in accordance with the present invention which comprises four positive electrode layers;

FIG. 6H is a eighth illustrative view of showing the coating and configuration of the electrode layer assembly of the composite lithium secondary battery in accordance with the present invention which comprises four positive electrode layers;

FIG. 7 shows the characteristic curves of the composite lithium secondary battery (LFP+LNCA) and the lithium secondary battery with a single positive electrode material (LFP, LNCA); and

FIG. 8 shows the characteristic curves of the composite lithium secondary battery (LFP+LNCM) and the lithium secondary battery with a single positive electrode material (LFP, LNCM).

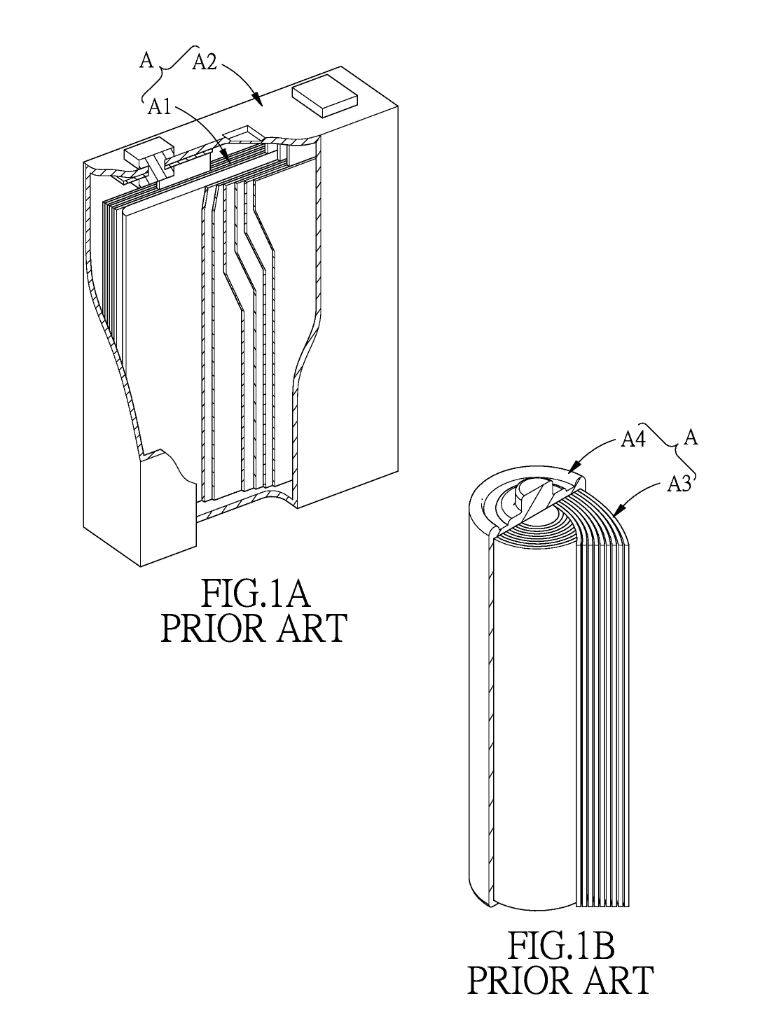

### DETAILED DESCRIPTION

The present invention will be clearer from the following description when viewed together with the accompanying drawings, which show, for purpose of illustrations only, the preferred embodiment in accordance with the present invention.

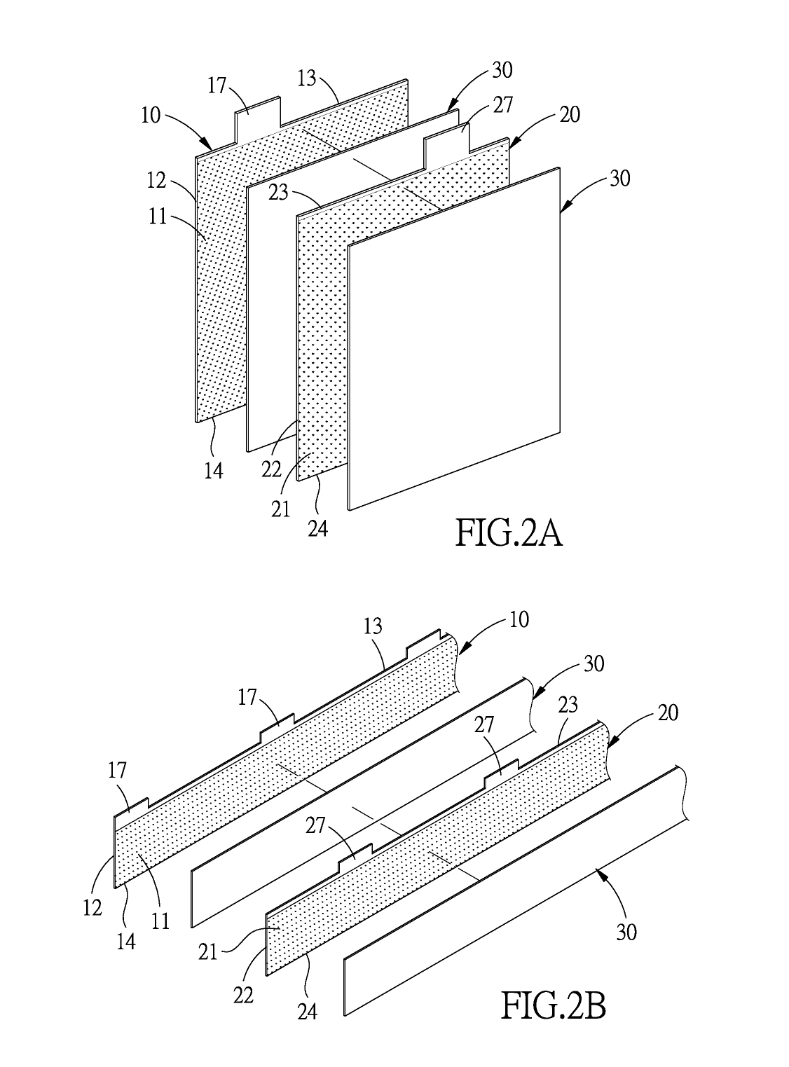

Referring to FIGS. 2A, 2B, 3 and 4-6H, a composite lithium secondary battery in accordance with the preferred embodiment of the present invention is shown, wherein an electrode layer assembly of the composite lithium secondary battery comprises: a plurality of positive electrode layers 10, a plurality of negative electrode layers 20 and a plurality of separating layers 30 disposed between the positive and negative electrode layers 10, 20. The positive and negative electrode layers 10, 20 and the separating layers 30 are superimposed one another to form the electrode layer assembly, and then the electrode layer assembly is put into a housing to form the composite lithium secondary battery. As shown in FIG. 2A, the electrode layers are assembled in a superimposed manner and to be put into a rectangular battery housing, and the layers as shown in FIG. 2B are superimposed on one another and roll up into a coil which is to be put into a circular battery housing. In this embodiment, as shown in FIGS. 2A and 2B, the electrode layer assembly includes a positive electrode layer 10, an inner separating layer 30, a negative electrode layer 20 and an outer separating layer 30 which are assembled together to form an electrode assembly. The electrode layer of the composite lithium secondary battery of the present invention comprises at two such electrode assemblies, the plurality of positive electrode layers 10 can be coated with different positive electrode materials, and the number of the electrode assembly can be increased based on the capacitance requirement.

As shown in FIG. 2, the positive electrode layer 10 includes two opposite surfaces 11, 12. Between the two opposite surfaces 11, 12 are defined two opposite lateral edges 13, 14 and two opposite ends 15, 16 which are shorter than the two opposite lateral edges 13, 14. The lateral edge 13 is provided with at least one positive electrode ear 17. Each of the two opposite surfaces 11, 12 is provided with a coating area which allows for coating of electrode reaction material for intercalation and deintercalation of positive electrode material, such as lithium ion.

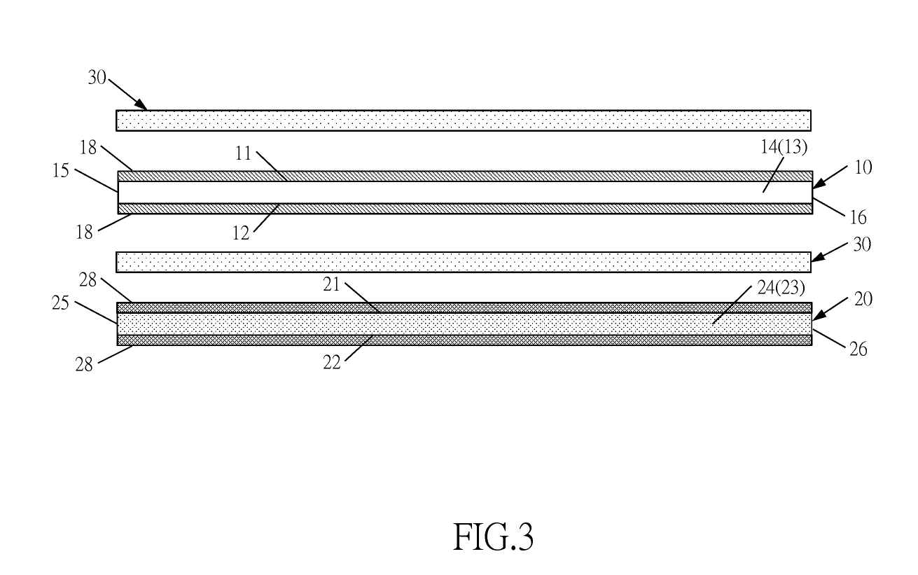

The two opposite surfaces 11, 12 of the respective positive electrode layers 10 are coated with the same positive electrode material which is LFP (LiFePO₄) or lithium-containing ternary oxide. At least one of the positive electrode layers 10 is coated with LFP, and at least one of the positive electrode layers 10 is coated with lithium-containing ternary oxide. As shown in FIG. 3, the two opposite surfaces 11, 12 of the respective positive electrode layers 10 are respectively formed into a coating layer 18 after being coated with the positive electrode material.

The LFP of the composite lithium secondary battery of the present invention is LiFePO₄ with olivine structure and lithium-containing ternary oxide. The lithium-containing ternary oxide is preferably chosen from the group consisting of LNCA (LiNixCoyAl_{1-x-y}O₂) and LNCM (LiNiCoMnO₂), so as to form the combination of (LFP+LNCA) or (LFP+LNCM).

The positive electrode layer 10 is formed by coating an aluminum substrate (such as aluminum foil) with positive electrode material. The positive electrode material can also includes conductive agent and adhesive agent which are used to apply the active substance formed by the lithium containing oxide to the aluminum substrate. The adhesive agent includes but is limited to resin adhesive.

The negative electrode layer 20 includes two opposite surfaces 21, 22. Between the two opposite surfaces 21, 22 are defined two opposite lateral edges 23, 24 and two opposite ends which are shorter than the two opposite lateral edges 23, 24. The lateral edge 23 is provided with at least one negative electrode ear 27. Each of the two opposite surface 21, 22 is provided with a coating area which allows for intercalation and deintercalation of negative electrode material of the electrode reaction material, such as lithium ion. As shown in FIG. 3, the two opposite surfaces 11, 12 of the respective positive electrode layers 10 are respectively formed into a coating layer 28 after being coated with the positive electrode material.

The negative electrode material of the composite lithium secondary battery of the present invention is selected from the carbon material of graphite or coke. More specifically, the negative electrode layer 20 is formed by coating a copper substrate (such as copper foil) with the negative electrode material. The negative electrode material can also include conductive agent and adhesive agent which are used to apply the carbon material to the copper substrate. The adhesive agent includes but is limited to resin adhesive. Besides, the separating layer 30 is a microporous or porous film which is used to close or block passage and separate the positive and negative electrode layers 10, 20, and the material of the separating layer 30 includes but is not limited to PP or PE.

What mentioned above are the structure and material of the positive electrode layer 10, the negative electrode layer 20 and the separating layer 30 of the preferred embodiment of the present invention, and for the coating area of the positive electrode layer 10, please refer to FIGS. 3-6H. The positive electrode material applied to the coating area is preferably the lithium-containing ternary oxide, LFP and LNCA or LNCM.

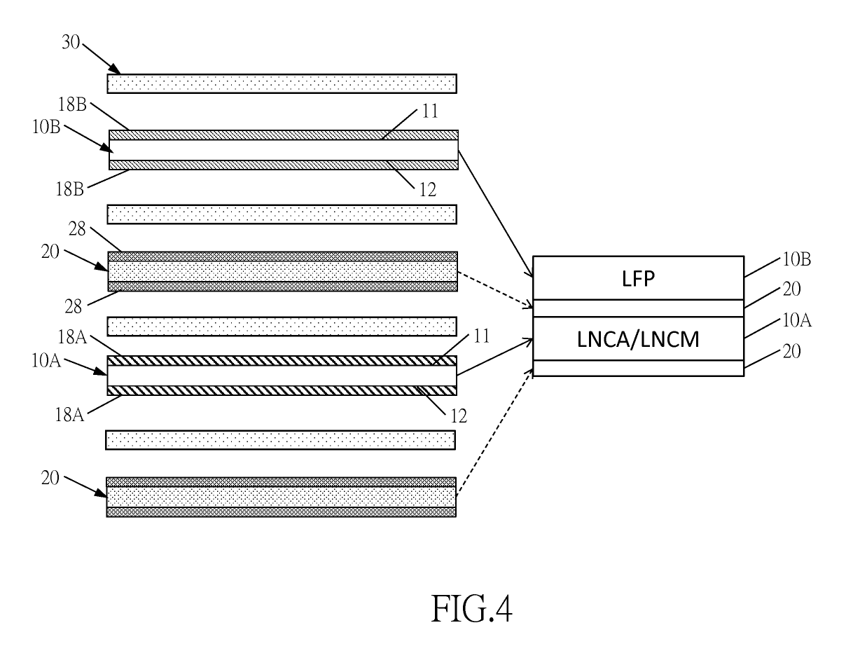

For easy explanation of the coating process, as shown in FIG. 4, the surface coated with the LNCA or LNCM is defined as a first coating layer 18A, and the positive electrode layer 10 with two opposite surfaces 11, 12 coated with the first coating layer 18A is defined as a ternary positive electrode layer 10A. The surface coated with LFP is defined as a second coating layer 18B, and the positive electrode layer 10 with two opposite surfaces 11, 12 coated with the second coating layer 18B is defined as an LFP positive electrode layer 10B. More specifically, the right part of FIG. 4 is a simplified view of the left part of FIG. 4. As shown in FIGS. 4, 5A and 6H, wherein the separating layer 30 is omitted, and only the configuration arrangement of the ternary positive electrode layer 10A, LFP positive electrode layer 10B and the plurality of negative electrode layers 20 is illustrated.

### Embodiment 1

As shown in FIG. 4, the composite lithium secondary battery includes a electrode layer assembly which includes two positive electrode layers, and the electrode layer assembly comprises: a ternary positive electrode layer 10A, a negative electrode layer 20, a LFP positive electrode layer 10B and a negative electrode layer 20. The ternary positive electrode layer 10A is coated with LNCA or LNCM.

### Embodiment 2

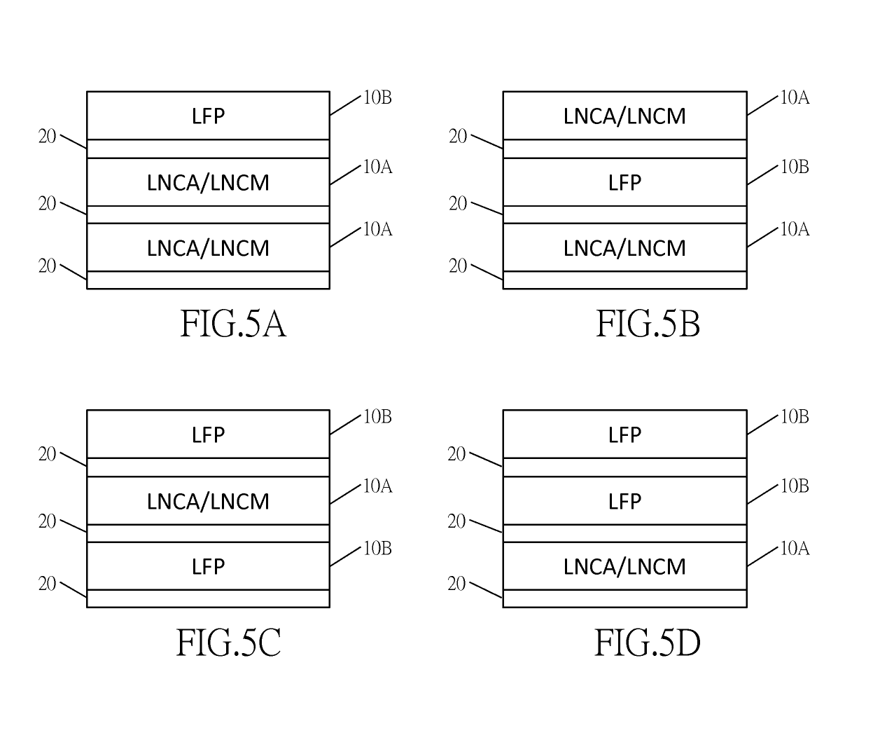

As shown in FIGS. 5A-5D, the composite lithium secondary battery includes a electrode layer assembly which includes three positive electrode layers, and the electrode layer assembly comprises: a LFP positive electrode layer 10B and two ternary positive electrode layers 10A which are superimposed one another (as shown in FIGS. 5A and 5B), or two LFP positive electrode layers 10B and a ternary positive electrode layer 10A which are superimposed one another (as shown in FIGS. 5C and 5D). In this embodiment, the ternary positive electrode layer 10A is coated with LNCA or LNCM, and a battery only uses a single type of lithium-containing ternary oxide.

### Embodiment 3

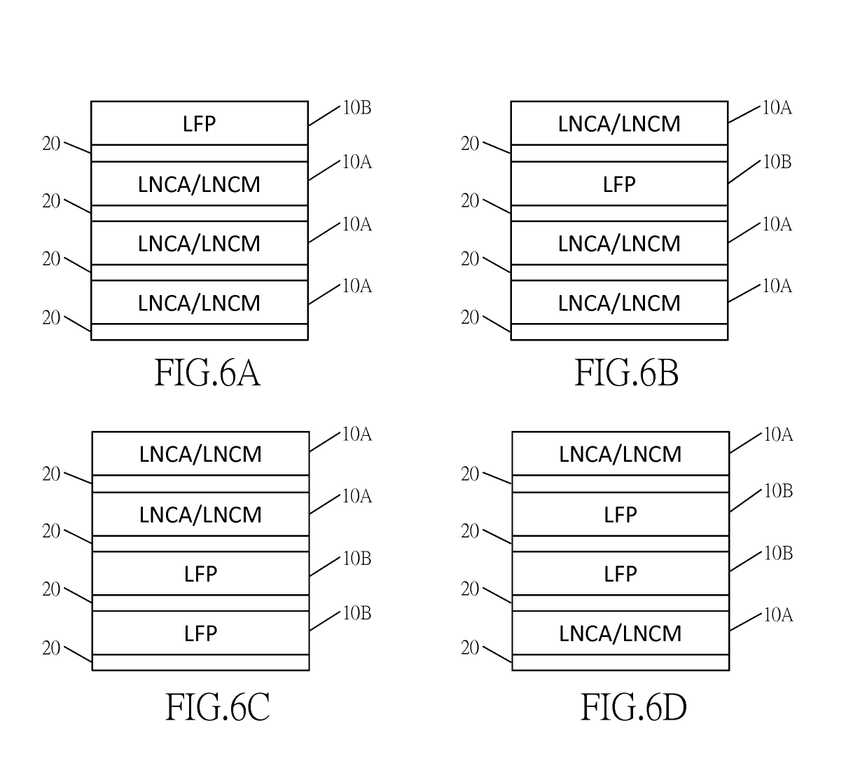

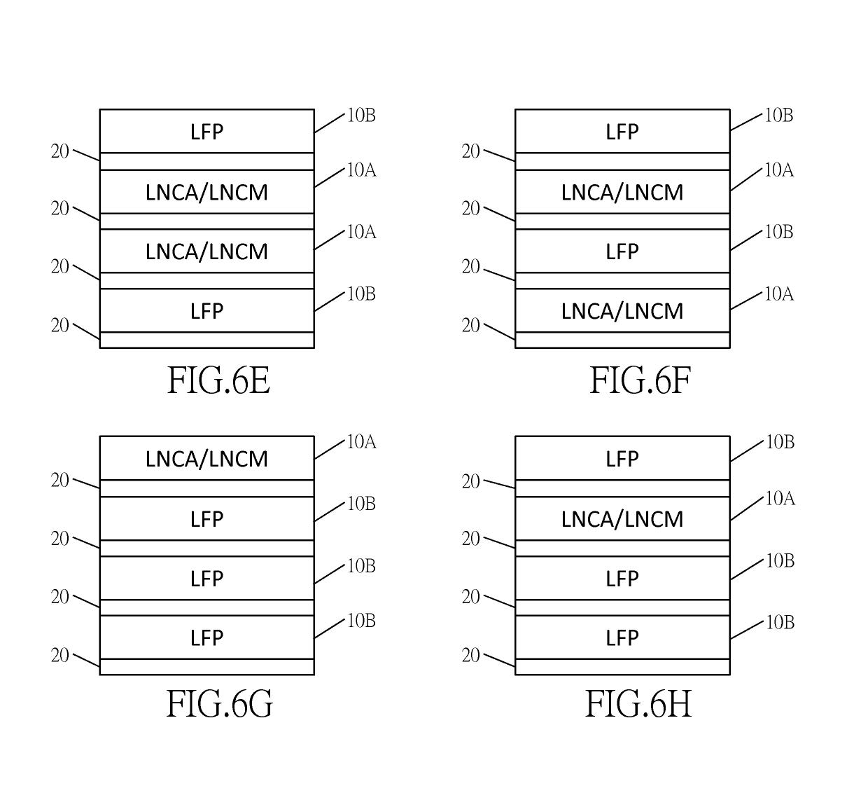

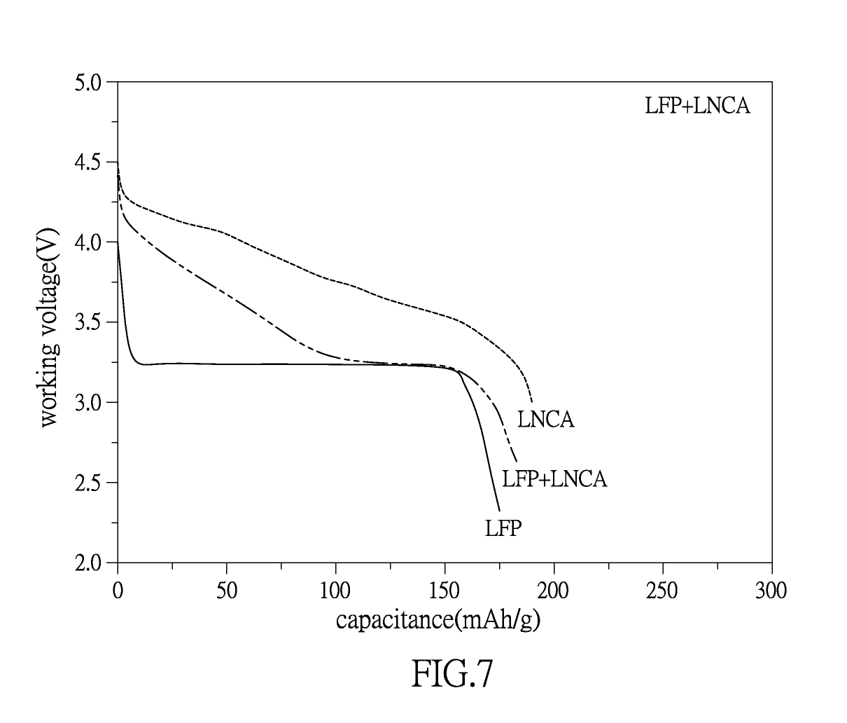

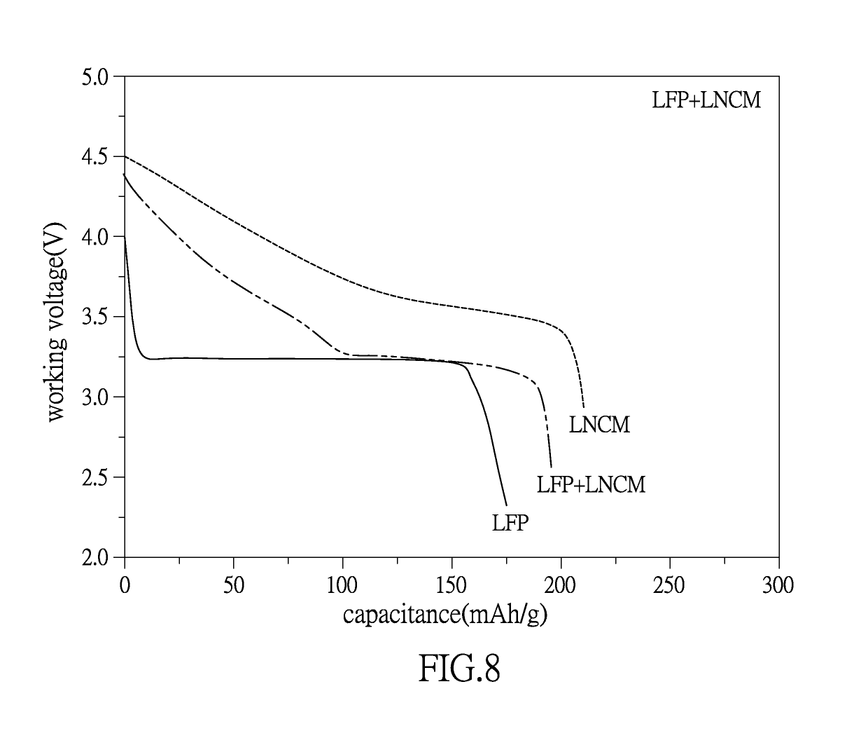

As shown in FIGS. 6A-6H, the composite lithium secondary battery includes a electrode layer assembly which includes four positive electrode layers, and the electrode layer assembly comprises: a LFP positive electrode layer 10B and three ternary positive electrode layers 10A which are superimposed one another (as shown in FIGS. 6A and 6B), or two LFP positive electrode layers 10B and two ternary positive electrode layers 10A which are superimposed one another (as shown in FIGS. 6C, 6D,6C and 6D), or three LFP positive electrode layers 10B and one ternary positive electrode layer 10A which are superimposed one another (as shown in FIGS. 6G and 6H). In this embodiment, the ternary positive electrode layer 10A is coated with LNCA or LNCM, and a battery only uses a single type of lithium-containing ternary oxide.

It should be understood that the number of the positive electrode layers 10 and the proportion between the LFP positive electrode layer 10B and the ternary positive electrode layer 10A are not limited to the abovementioned embodiments, but can be adjusted as desired, as long as the proportion and the coating area of the LFP and the lithium-containing ternary oxide can improve the work efficiency of the lithium secondary battery.

While we have shown and described various embodiments in accordance with the present invention, it is clear to those skilled in the art that further embodiments may be made without departing from the scope of the present invention.

What is claimed is:

1. A composite lithium secondary battery comprising an electrode layer assembly, and the electrode layer assembly comprising: a plurality of positive electrode layers, a plurality of negative electrode layers and a plurality of separating layers disposed between the positive and negative electrode layers, wherein the positive and negative electrode layers and the separating layer are superimposed one another to form the electrode layer assembly, the positive electrode layers being provided with positive electrode materials which allow for intercalation and deintercalation of an electrode reaction material, at least one positive electrode ear being provided at a lateral edge of each of the positive electrode layers, two opposite surfaces of each of the positive electrode layers being provided with the positive electrode materials, the negative electrode layers being provided with negative electrode materials which allow for intercalation and deintercalation of the electrode reaction material, at least one negative electrode ear being provided at a lateral edge of each of the negative electrode layers; the composite lithium secondary battery being characterized in that:
the two opposite surfaces of each of the respective positive electrode layers are coated with the same positive electrode material which is selected from the group consisting of LiFePO₄ and lithium-containing ternary oxide, at least one of the positive electrode layers is coated with LiFePO₄, and at least another one of the positive electrode layers is coated with lithium-containing ternary oxide.

2. The composite lithium secondary battery as claimed in claim 1, wherein the lithium-containing ternary oxide is selected from the group consisting of LiNixCoyAl_{1-x-y}O₂ and LiNiCoMnO₂.

3. The composite lithium secondary battery as claimed in claim 1, wherein the positive electrode materials include olivine LiFePO₄ and LiNixCoyAl_{1-x-y}O₂.

4. The composite lithium secondary battery as claimed in claim 3, wherein the composite lithium secondary battery has a working voltage ranging from 4.5 V to 2.7 V, and a capacitance over 175 mAh/g.

5. The composite lithium secondary battery as claimed in claim 2, wherein the positive electrode materials include LiFePO₄ and LiNixCoyAl_{1-x-y}O₂

6. The composite lithium secondary battery as claimed in claim 5, wherein the composite lithium secondary battery has a working voltage ranging from 4.5 V to 2.7 V, and a capacitance over 175 mAh/g.

7. The composite lithium secondary battery as claimed in claim 1, wherein the positive electrode materials include LiFePO₄ and LiNiCoMnO₂.

8. The composite lithium secondary battery as claimed in claim 7, wherein the composite lithium secondary battery has a working voltage ranging from 4.4 V to 2.6 V, and a capacitance over 185 mAh/g.

9. The composite lithium secondary battery as claimed in claim 2, wherein the positive electrode materials of the composite lithium secondary battery include LiFePO₄ and LiNiCoMnO₂.

10. The composite lithium secondary battery as claimed in claim 9, wherein the composite lithium secondary battery has a working voltage ranging from 4.4 V to 2.6 V, and a capacitance over 185 mAh/g.

11. The composite lithium secondary battery as claimed in claim 1, wherein the two opposite surfaces of the respective positive electrode layers are respectively formed into a coating layer after being coated with the positive electrode material, the coating layer coated with LiNixCoyAl_{1-x-y}O₂ or LiNiCoMnO₂ is defined as a first coating layer, the positive electrode layer whose two opposite surfaces coated with the first coating layer is defined as a ternary positive electrode layer, the coating layer coated with LiFePO₄ is defined as a second coating layer, the positive electrode layer whose two opposite surfaces coated with the second coating layer is defined as an LiFePO₄ positive electrode layer, the electrode layer assembly comprises one said LiFePO₄ positive electrode layer and two said ternary positive electrode layers which are superimposed one another, or two said LiFePO₄ positive electrode layers and one said ternary positive electrode layer which are superimposed one another.

12. The composite lithium secondary battery as claimed in claim 1, wherein the two opposite surfaces of the respective positive electrode layers are respectively formed into a coating layer after being coated with the positive electrode material, the coating layer coated with LiNixCoyAl_{1-x-y}O₂ or LiNiCoMnO₂ is defined as a first coating layer, the positive electrode layer whose two opposite surfaces coated with the first coating layer is defined as a ternary positive electrode layer, the coating layer coated with LiFePO₄ is defined as a second coating layer, the positive electrode layer whose two opposite surfaces coated with the second coating layer is defined as an LiFePO₄ positive electrode layer, the electrode layer assembly comprises one said LiFePO₄ positive electrode layer and three said ternary positive electrode layers which are superimposed one another, or two said LiFePO₄ positive electrode layers and two said ternary positive electrode layers which are superimposed one another, or three said LiFePO₄ positive electrode layers and one said ternary positive electrode layer which are superimposed one another.

13. The composite lithium secondary battery as claimed in claim 1, wherein the negative electrode materials include carbon materials of graphite or coke.

14. The composite lithium secondary battery as claimed in claim 1, wherein the positive electrode layers, the negative electrode layers and the separating layers are superimposed one another and rolled up into a coiled core assembly.
